(19) United States
(12) Patent Application Publication
(10) Pub. No.: US 2003/0185654 A1
(43) Pub. Date: Oct. 2, 2003

(54) Device for preparing adhesive bindings of blocks and brochures, especially for small print runs

(76) Inventor: Horst Rathert, Minden (DE)

Correspondence Address: McGLEW AND TUTTLE, P.C., SCARBOROUGH STATION, SCARBOROUGH, NY, 10510-0827, US

(21) Appl. No.: 10/385,537

(22) Filed: Mar. 11, 2003

(30) Foreign Application Priority Data
Mar. 12, 2002 (DE) 102 10 843.9-26

(51) Int. Cl. B42C 9/00

(52) U.S. Cl. 412/37

(57) ABSTRACT

The present invention pertains to a device of compact design for preparing adhesive bindings of blocks and brochures as well as to a process that can be carried out by means of a device according to the present invention, wherein it has a linear conveying system with clamping rails moving to and fro, whereby the blocks are conveyed in at least two steps.

Processing operations are performed on the block during the resulting phases of movement and stop phases.

The clamping rails have different shapes at the contact surface toward the block depending on the requirement of the stations fed by them.

The complete unit makes possible the universal production of commemorative volumes, brochures and folded brochures and comprises for this purpose the application of end papers, the folding and the application of covers. The end papers are fed flush to the finished spine after the processing of the spine. The gluing of the block spines is carried out at right angles to the height of the block during the stopping of the block by a lifting movement of the gluing mechanism. The feeding of slip-fold strips is coupled with the lifting movement of the gluing mechanism. The delivery is carried out gently by means of a rotatable system of clamping stations.

The present invention pertains to a device for preparing adhesive bindings of blocks and brochures, especially for small print runs, according to the preamble of claim 1, as well as to a process for preparing adhesive bindings of blocks and brochures, especially for small print runs, according to the preamble of claim 10.

Within the framework of the production of brochures, stacks collated before are processed on the spine by milling in the case of adhesive bindings, subsequently coated with glue and then hung into a cover. The cover is now firmly bonded to the spine of the block.

In certain special types of brochures, the cohesion of the sheets is achieved by means of a slip-fold strip, which is firmly bonded to the spine and is also glued on the side to the first and last sheets of the block. The cover is glued to the block in a linear pattern only on the side, on one side or on both sides, in the vicinity of the spine. Many different types of devices have been known for this type of production. The feature common to all solutions is that a slip-fold strip and then the cover are placed on the spine.

To prepare adhesive-bound blocks for hardcover books, the block must be provided with an end paper each in the front and back corresponding to the manner common in bookbinding. The spine is often not processed in the case of, e.g., thread-stitched blocks, thread sealing or perforation binding. The spine is always coated with glue and then folded.

Devices for preparing adhesive binding, which can perform all the operations described, are commonly used in the bookbinding industry. However, these are always machines operating according to complicated principles, which cannot be used economically for small print runs.

The feeding of front and back end papers is always problematic in all these machines when the spine of the block shall be milled during the adhesive binding. The reasons for this are as follows:

The end papers are usually introduced into the feed conveying mechanism in front of the conveying system of the adhesive binding device proper. Because of the milling off on the spine, the end papers are fed in an elevated position by the amount milled off compared with the spine, coated with glue in a linear pattern, and pressed onto the block. Contamination with glue and skew bonding of the end papers are often brought about by this procedure.

The end papers must be attached higher by a certain tolerance because of the possible binding differences in order not to be cut during milling.

Therefore, they are not located exactly at the level of the spine after the milling and therefore they also cannot be connected intensely to the spine of the block by means of the spine glue.

If a folding station shall be provided in a device for preparing blocks and folded brochures, this results in a very long adhesive binding device.

If the placement of end papers is possible, the length of the feed area of the adhesive binding device and consequently the overall length of the unit increase considerably. This is completely unacceptable especially in the case of small print runs.

Another weak point of prior-art devices of the type mentioned is generally also the delivery device, especially in the case of compact adhesive binding units, because the blocks freshly coated with glue on the spine often fall out of the conveying system and onto a chute, with which they are brought into the horizontal position from the vertical position. In other designs, they are deposited on a longitudinal conveying system, on which they are conveyed in a helical pattern into the horizontal position. The fresh blocks are now diagonally distorted and the spine glue is correspondingly stressed.

To avoid the disadvantages in terms of quality in the products, a cross stack delivery device, in which the blocks are pushed out at right angles to the direction of conveying, is therefore often used in low-speed adhesive binding devices, so that the blocks are stacked standing on their spines next to one another. However, this delivery does not permit an in-line coupling with a downstream machine or drying section.

Another problem of the adhesive binding delivery device during the processing of brochures and especially of brochures with flaps taken up on the cover is the release from the clamping system after the pressing on of the cover, because the opening clamp will again tear open the lateral bonding of the cover with the block and the outer sheets are displaced in milled blocks when the clamp is again lowered.

In another design, the opening of the bond is prevented by the transfer of the block into clamp carriages, which hold the block together laterally in the area of the side gluing. However, sharp bends are frequently formed now in the cover close to the spine in the case of thicker cover materials.

Based on the state of the art described, the basic object of the present invention is to make possible the qualitatively better and more economical processing of commemorative volumes, brochures and folded brochures in the case of smaller print runs.

This object is accomplished by the characterizing features of claim 1 with respect to the device and by the characterizing features of claim 10 with respect to the process, and special variants of the present invention appear from the features of the subclaims referred back to the said claims.

The device according to the present invention is a linearly arranged system with block conveying proceeding forward stepwise through a conveying device performing alternating movement. Two opposite clamping rails, which belong to the conveying device and are guided in a suitable manner, clamp the blocks or stacks of paper by an opening and closing movement.

The individual blocks are conveyed through the processing stations of the device in at least two steps, and a certain area of the clamping rails is always associated with the corresponding processing station and can therefore be adapted in terms of its shape. During the return movement of the clamping rails, the blocks are held according to the present invention in the position reached by an additional holding device. At least two phases of movement and at least two stop phases are thus formed during the conveying of a block.

Processing operations are performed on the block during both the phases of movement and the stop phases.

The blocks fed in automatically or inserted manually are clamped in the inserted position by the clamping rails, conveyed in the first step over the spine processing unit and into the first stop position, in which the end papers are applied, slip-fold strips are optionally fed in, and the gluing of the spine is carried out, while the clamping rails return into their starting position.

The area of the clamping rails that clamps the block for the first step may be designed for the conveying over the milling mechanism such that the block has only a small overhang. An optimally straight milling surface is obtained as a result. The small overhang does not interfere with the side gluing and the pressing on of slip-fold strips and the cover, as it would do in usual adhesive binding devices, because the part of the clamping rails thus designed is not engaged during these processing operations.

The block is held by a holding device in the first stop position, while the block conveying device is again returning into its starting position. This holding device is coordinated by the design with the operations taking place in this position.

According to the present invention, the end papers are fed in only in this position in the known manner by means of rotary feed units, after the spine of the block has already been milled off. They are now aligned by a stop plate under the spine of the block exactly flush with the spine of the block.

Incorrect positioning, milling of the end paper and linear auxiliary gluing are thus ruled out. The end papers are bound completely into the spine glue. Better quality is achieved as a result with a simplified process.

The coating of the spine with glue is carried out by a gluing roller moved to and fro by a gluing stroke under the spine at right angles to the direction of conveying. The thickness of the glue film applied is determined by a scraper. The glue pan is somewhat lowered during the return stroke in order to prevent the contact of the gluing roller with the spine of the block, which has possibly been provided meanwhile with a slip-fold strip. The scraper, which determines the thickness of the glue film applied, is now released. Contamination of the scraper with glue is flushed away by the gluing roller rotating backward.

The application and removal of the glue film at the head and foot of the block can now be achieved by means of simple scrapers on the gluing roller. The gluing boundary on the spine of the block can be made much more accurate than in the case of gluing in the direction of conveying with cyclically controlled scrapers, as is known from the state of the art. The relatively slow movement of the gluing roller prevents the build-up of an undefined static pressure, which may lead to the inflow of glue into the block.

Contamination on the glue scraper, which generates a narrow glue-free track on the gluing roller, does not lead to the non-bonding of sheets and to interruption of the spine glue in the direction of stressing, unlike in the case of longitudinal gluing.

A double roller may also be arranged in the glue pan for gluing with hot melt adhesives, in which case each of the two rollers can apply a glue film of different thickness.

If the folding operation is not carried out, twofold gluing can also be achieved by the forward and return stroke of one gluing roller by applying, e.g., a thin glue film with close contact with the spine of the block during the forward stroke and a thick glue film with a greater distance between the gluing roller and the spine of the block during the return stroke. The lowering movement of the gluing mechanism during the return stroke is limited to generate the distance between the gluing roller and the spine of the block.

The application of the slip-fold strip is coupled with the spine gluing in terms of movement. A suction plate pivotable with the gluing mechanism takes up the slip-fold strip cut to the desired length and presses it onto the spine surface of the block at the end of the gluing stroke. The slip-fold material is fed in as is usually done in the case of transverse folding. Arriving from the roll, the web material is driven by rollers and forwarded by a certain amount corresponding to the width of the slip-fold strip, fed to a cross-cutting means and cut there. The slip-fold strip to be cut off is already fixed by the suction plate during the cutting.

In the next step, the block is again grasped by the clamping rails of the conveying device, conveyed into the second stop position via the side gluing unit, and transferred there into a starshaped delivery unit which can be rotated stepwise.

The block is now clamped only by another area of the clamping rails, where the side gluing is not hindered and place is created for the cover during pressing on by a corresponding design.

The star-shaped delivery unit with block clamps arranged in a star-shaped pattern takes over the block for pressing on the cover and the slip-fold strip.

The cover is pressed on in the usual manner first on the spine and then on the sides. The pressing on the sides finally takes place when the clamping rails have left the pressing-on area during the return stroke and the cover can thus come into contact with the block without bending sharply and the lateral bonding is not torn up again after the releasing of the lateral pressing rails.

The block with the cover is pivoted out of the feed area of the conveying device by a pivoting step of the star-shaped delivery unit and is brought into a nearly horizontal position from the vertical position. The new block can meanwhile be fed in. The deposited block is released by the discharge clamp of the star-shaped delivery unit and brought onto a discharge conveyor, where it is moved on with the spine facing forward and an in-line coupling with downstream machines can be established. The delivery device is arranged at an ergonomically favorable level for manual removal.

The clamped deposition of the individual block spares the fresh spine gluing and prevents cracks in the glue film and deformations of the block.

The cover is fed in from the opposite direction, so that the paths of the block and cover do not cross and intersect up to the collation position for reasons of accessibility and clarity. The covers can likewise be fed at an ergonomically favorable level.

During the stopping of the individual block, the cover is aligned accurately with the position of the block, as a result of which high accuracy of position can be achieved.

The present invention will be described below on the basis of an advantageous embodiment with reference to the attached drawings. In the drawings,

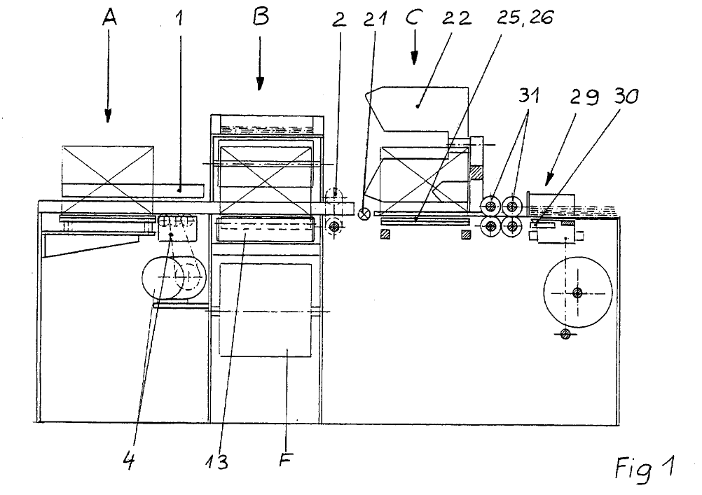

FIG. 1 shows a side view of the device according to the present invention,

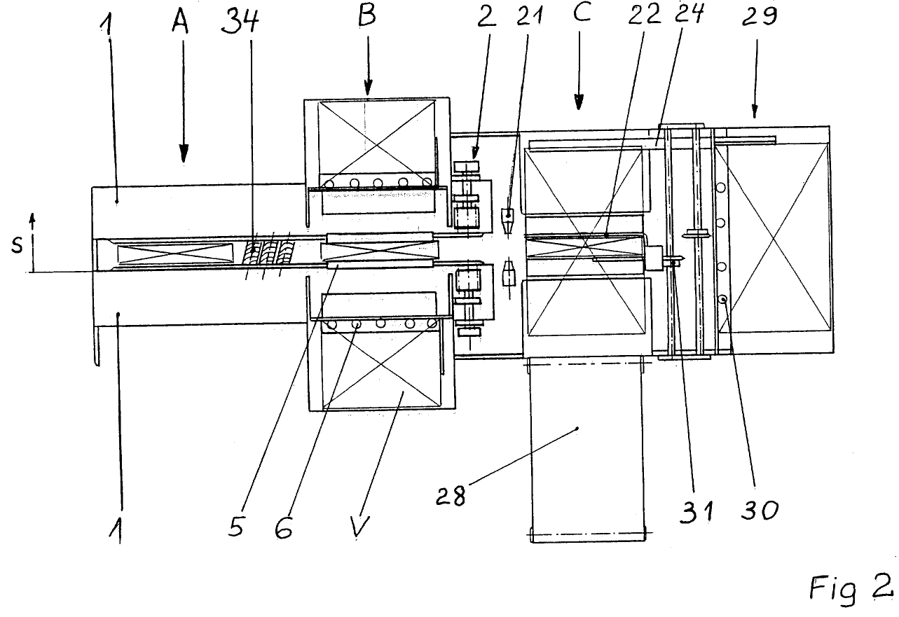

FIG. 2 shows a top view of the device according to the present invention,

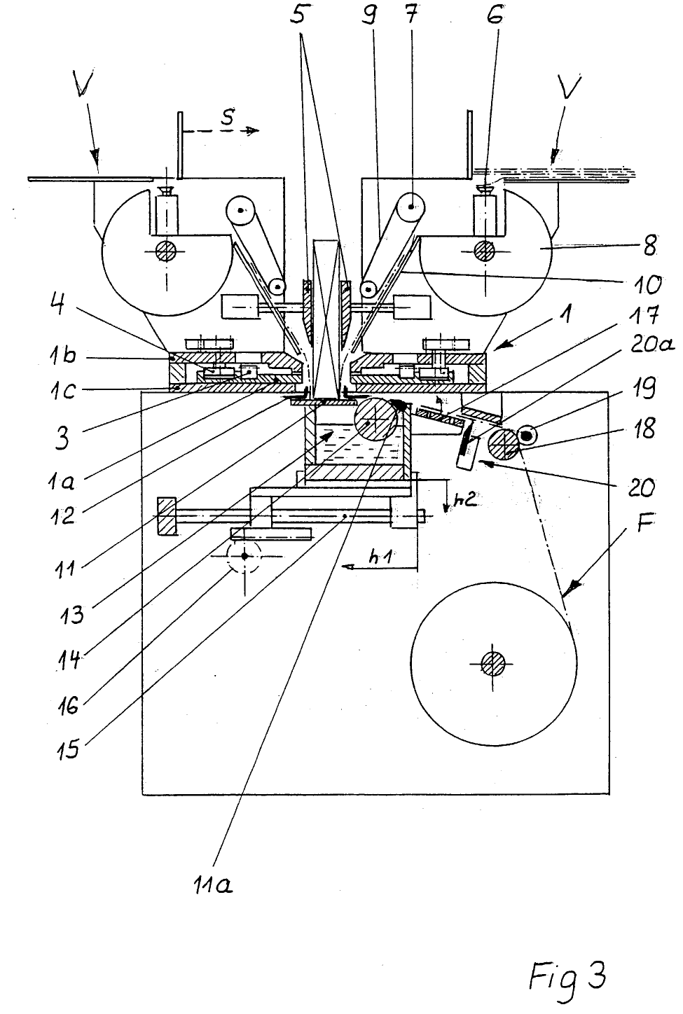

FIG. 3 shows a section through the end paper placing, slip-fold strip feeding and gluing station, and

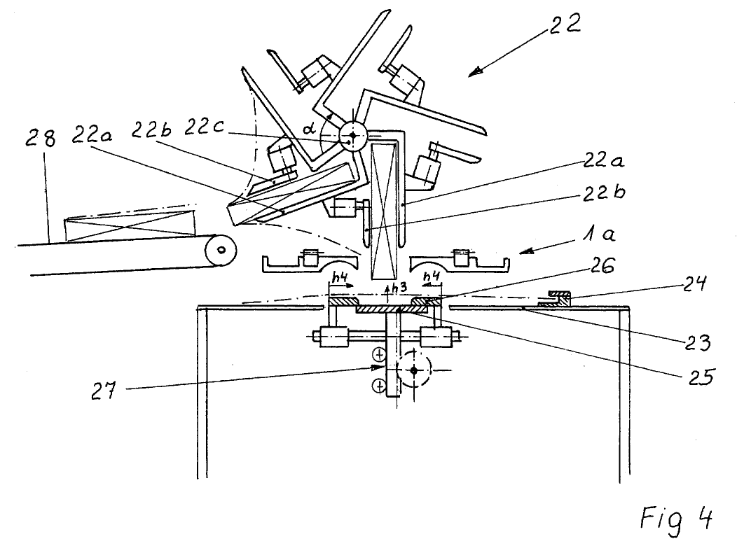

FIG. 4 shows a section through the pressing station and the delivery device.

The stepwise conveying of the individual block is carried out by the conveying device 1 with the clamping rails 1 a running to and fro, the upper guide 1b and the lower guide 1c. The stroke of the conveying device is always generated via toothed rack drives 2, which engage a toothed rack 3 on the clamping rails 1a.

The clamping stroke of the clamping rails 1a is generated by eccentric rollers 4.

The conveying movements take place on both sides of the block absolutely synchronously. For adaptation to the thickness of the format, one of the two lateral clamping rails 1a, especially the one on the right-hand side in the top view, is adjusted when viewed in the direction of conveying, which is illustrated by the path of adjustment in the representations.

In the simplest design of the feed, the blocks are placed manually in the intake position A. The insertion may be carried out with the forward stroke and return stroke running as soon as the previous block has left the position.

On the way from position A to position B, the block passes over a processing unit to prepare a straight block spine, the milling means 34 in this exemplary embodiment. To save space, the processing tools for milling, equalizing and notching have a roller-shaped design.

The block is taken over in position B by the holding clamps 5 of a separate holding device before the clamping rails Ia are released and return.

An end paper V is separated by a suction bar 6 during the conveying movement and conveyed further by means of a roller 7, which runs against a drum 8, and the belt 9, and the said end paper is guided by a plate 10.

The end paper with its back reaches the level of the spine of the block in a time-coordinated manner when the clamping rails I a have opened. The end paper is positioned by the plate 11 on both sides of the block exactly at the level of the spine and held by the auxiliary clamps 12, which can be actuated, e.g., by pneumatic auxiliary means, not shown.

The aligning plate 11 belongs to the gluing station and forms the cover and the scraper of a gluing mechanism, which is designated by 13 in its entirety. The gluing mechanism 13 with a gluing roller 14 is moved through under the spine of the block (stroke h1) along a guide 15 by a drive 16, while the gluing roller 14 performs a synchronous rotary movement, so that its surface rolls against the spine of the block and transfers the glue. The thickness of the glue film is set by displacing the plate 11 (scraper). The application and removal of the glue film at the head and foot can be achieved by scraping off the gluing roller in the corresponding areas by means of narrow scrapers, not shown, which can be displaced along the length of the gluing roller.

The glue pan can be heated for processing hot melt adhesives.

The gluing mechanism 13 is lowered somewhat downward during its return stroke to prevent any contact from becoming established with the spine that was meanwhile folded (stroke h2). The scraper 11 is released when the gluing roller is rotating backward during the return stroke. Contamination with glue on the scraper is now flushed off automatically.

If no folding slip-fold strip is fed, the gluing roller 14 can apply another, e.g., thicker glue film during the return stroke. The glue film thickness is determined now by the return scrapers 11a, and the lowering h2 takes place until the correct distance becomes established between the roller and the spine of the block.

A suction plate 17, which takes up the slip-fold strip cut to the desired length and presses it to the spine of the block at the end of the gluing stroke h1, is arranged pivotably at the glue pan.

Arriving from the roll, the folding material F is fed by a roller 18 with counterrollers 19 to the cutting means 20 with the knife 20a by means of simple drive means, not shown, and the conveying stroke corresponds to the length to be cut off. The suction plate 17 holds the slipfold strip when the cut is taking place.

The block, which is glued on the spine and is provided with end papers and slip-fold strips, is again clamped by the clamping rails 1a in position B and conveyed into position C. The belt 9 is now released by means of a simple actuating means, not shown. This second area of the clamping rails is designed such that the block will have a greater overhang so that the side gluing can take place during the stroke from B to C. It is preferably carried out by means of prior-art nozzle-type application means 21.

The block is taken up in position C by a clamping station of the star-shaped delivery unit 22, which clamping station is standing ready, and clamped by the stationary clamp side 22a and the movable clamp side 22b.

The cover lying ready on the table 23 is aligned by a guide 24 and stops, not shown, and is pressed onto the spine of the block by a pressing table 25 and pressing rails 26. The pressing table 25 performs a vertical movement h3 for this purpose, driven by a toothed rack drive 27.

After the clamping rails 1a have left the area during the return stroke, the lateral pressing is performed by the pressing rails 26 with the stroke h4.

The pressing rails 26 and the pressing table 25 return, and the block is brought into a position slightly inclined in relation to the horizontal direction by pivoting the star-shaped delivery unit 22 by one pitch a around the axis of rotation 22c. To obtain the desired slope angle, the star-shaped delivery unit is divided into five parts. The clamp 22b opens and the block slides on the sloped surface of the clamp 22a onto a delivery belt 28.

In another embodiment, not shown here, the block may also be pushed from the clamp 22 onto the conveyor 28. The star-shaped delivery unit is divided into four in this case and the direction of delivery is exactly horizontal.

Separated by suction units 30, the covers are fed to scoring rollers in the known manner in a feeder 29 and conveyed further into position C, where the aligning of the cover is carried out.

1. Device for preparing adhesive bindings of blocks and brochures, especially for small print runs, with a conveying device provided with clamping rails for fixing the blocks or brochures for moving the blocks or stacks of paper to be bound through the device, a processing unit for preparing a straight block spine, a gluing station for applying glue to the spines of the blocks or stacks of paper, and a delivery device for removing the completely glued blocks or stacks of paper, characterized in that the said conveying device (1a, 1b, 1c) has a separate holding means for fixing the block or stack of paper being processed in the gluing station during the return of the clamping rails into the pick-up position for a new block or stack of paper.

2. Device for preparing adhesive bindings of blocks and brochures in accordance with claim 1, characterized in that the holding means has at least two said holding clamps (5) that clamp the flat sides of the block or stack of paper in their upper area facing away from the adjacent block spine.

3. Device for preparing adhesive bindings of blocks and brochures in accordance with claim 1 or 2, characterized in that viewed in the direction of conveying of the blocks or stacks of paper, a feed unit for end papers to be placed on the front and back sides of the block or stack of paper is arranged adjacent to the processing unit for preparing the straight block spine, the said feed unit aligning the end papers flush with the spine edge of the block or stack of paper.

4. Device for preparing adhesive bindings of blocks and brochures in accordance with claim 1, characterized in that the gluing station has a said gluing mechanism (13) movable at right angles to the direction of conveying with at least one said gluing roller (14), wherein the said gluing roller (14) is driven by the transverse movement of the said gluing mechanism (13), so that it rolls on the spine of the block, and wherein the thickness of the glue film can be set by setting a said scraper (11) extending over the entire length of the roller.

5. Device for preparing adhesive bindings of blocks and brochures in accordance with claim 4, characterized in that the said gluing roller (13) has, adjustably over its length, two scrapers, which scrape free the roller surface in the areas for the head and the foot of the block.

6. Device for preparing adhesive bindings of blocks and brochures in accordance with one of the claims 1 through 5, characterized in that a feed station for slip-fold strips with a said cutting means (20) and with a said suction table (17) is associated with the gluing station, wherein the slip-fold strips are cut to the desired length at the said feed station and they are subsequently fed to the said suction table (17), which is brought into position under the spine of the block after the gluing operation and presses the slip-fold strip to the glued block spine by a lifting movement.

7. Device for preparing adhesive bindings of blocks and brochures in accordance with one of the claims 1 through 5, characterized in that the delivery device has a said delivery unit (22) with said clamping stations (22a, 22b), which are arranged in a star-shaped pattern and take over the block from the longitudinal conveying and lay it down it the clamped state after pressing on the cover or slip-fold strip.

8. Device for preparing adhesive bindings of blocks and brochures in accordance with one of the claims 1 through 7, characterized in that the said clamping rails (1a) of the said conveying device (1a, 1b, 1c) have at least two areas of different shapes arranged one after another in the direction of conveying, wherein the areas have an overhang adapted to the different conditions of the processing stations.

9. Device for preparing adhesive bindings of blocks and brochures in accordance with one of the claims 1 through 8, characterized in that the processing unit is designed as a said milling station (34) to prepare a straight block spine, and the milling is carried out with roller-shaped tools.

10. Process for preparing adhesive bindings of blocks and brochures, especially for small print runs, with a device in accordance with claim 1, in which the blocks and brochures are guided through the device by means of a conveying device provided with clamping rails for fixing the blocks and brochures, wherein a straight block spine is first prepared in a processing unit, after which glue is applied to the spines of the blocks or brochures in a gluing station, and after the completion of the gluing, the completely glued blocks or stacks of paper are discharged, characterized in that the conveying through the device takes place in at least two steps by a forward and return movement of the said clamping rails (1a) clamping the blocks laterally on the left and right when viewed in the direction of conveying, the blocks are taken over by a said separate holding means (5) during the return conveying stroke of the said clamping rails (1a) and pass through a conveying stop phase, during which the gluing on the spine of the book takes place, and that processing operations are carried out on the block both during the movement and during the stop.

11. Process for preparing adhesive bindings of blocks and brochures in accordance with claim 10, characterized in that the placement of end papers to the front and rear sides of the block is carried out after the preparation of the straight block spine, the spine edge of the end papers being aligned flush with the spine edge of the block.

12. Process for preparing adhesive bindings of blocks and brochures in accordance with claim 10 or 11, characterized in that the gluing of the spine of the block is carried out by a said gluing mechanism (13) movable at right angles to the direction of conveying with at least one said gluing roller (14), wherein the said gluing roller (14) is driven by the transverse movement of the said gluing mechanism (13), so that it rolls on the spine of the block, and that the glue film thickness is set on the whole by the setting of a said scraper (11) extending over the entire length of the roller.

13. Process for preparing adhesive bindings of blocks and brochures in accordance with one of the claims 10 through 12, characterized in that slip-fold strips are cut to the desired length during the gluing operation and are subsequently fed to a said suction table (17), which is brought into position under the spine of the block with the gluing movement and presses the slip-fold strip onto the glued block spine by a lifting movement.

14. Process for preparing adhesive bindings of blocks and brochures in accordance with one of the claims 10 through 13, characterized in that the blocks are delivered by means of the delivery device by a said delivery unit (22) with said clamps (22a, 22b) arranged in a star-shaped pattern, which take over the block from the longitudinal conveying and put it down in the clamped state after the cover or the slip-fold strip has been pressed on.

15. Process for preparing adhesive bindings of blocks and brochures in accordance with one of the claims 10 through 14, characterized in that covers are fed to the blocks from a direction that is opposite the direction in which the blocks are conveyed.

16. Process for preparing adhesive bindings of blocks and brochures in accordance with claim 12, characterized in that double glue application can be carried out by a twofold transverse lifting movement of the said gluing roller (14), and the thickness of the glue film can be varied from one stroke to the next by adjusting the said scraper (11).

17. Process for preparing adhesive bindings of blocks and brochures in accordance with claim 12, characterized in that glue is applied twice, e.g., as a thin film and as a thick film, by two rollers arranged one after another in the direction of the gluing stroke with different scraper settings.

18. Process for preparing adhesive bindings of blocks and brochures in accordance with one of the claims 10 through 17, characterized in that when the device is operated without the feed of slip-fold strips, two glue applications with different film thicknesses can be performed during the gluing forward stroke and the gluing return stroke, and the glue film thickness is determined by a forward scraper and a return scraper, and the lowering of the gluing mechanism during the return stroke is adapted to the thickness of the glue film applied. 10
